(19) United States
(12) Patent Application Publication
(10) Pub. No.: US 2025/0187963 A1
(43) Pub. Date: Jun. 12, 2025

(54) Mobile Lagoon Cleaning Process and Sewer System

(71) Applicant: The Waste Not Group, LLC, Raleigh, NC (US)

(72) Inventors: Carolyn Cole, Pinehurst, NC (US); Lana Allen, Pinehurst, NC (US); Lewis Fettermann, Clinton, NC (US); Beverly McDonald, Pinehurst, NC (US)

(21) Appl. No.: 18/842,185

(22) PCT Filed: Mar. 23, 2023
(86) PCT No.: PCT/US2023/016156

§ 371 Date: Aug. 28, 2024

Related U.S. Application Data
(60) Provisional application No. 63/322,671, filed on Mar. 23, 2022.

(51) Int. Cl. C02F 11/121; C02F 103/20; C05F 3/00; C05F 17/40

(52) U.S. Cl. CPC C02F 11/121; C05F 3/00; C05F 17/40; C02F 2103/20; C02F 2307/00

(57) ABSTRACT

The present teachings generally relate to methods, devices, and systems for the cleaning and utilization of waste from livestock waste treatment lagoons, conversion of such animal waste into value added materials for effective utilization, and installation and use of improved sewer systems in animal production facilities and/or farms thereby eliminating the need of currently operated swine lagoons and spray-field systems for waste capture and retainment.

### FIELD

The present invention relates generally to animal waste management methods and systems, and more particularly to methods and systems for the cleaning of livestock waste treatment lagoons (or “effluent ponds”), use and installation of swine sewer systems, and conversion of animal waste into value added materials for effective utilization.

### BACKGROUND

A predominantly used method for the management and disposal of swine waste is the “lagoon and spray-field system” wherein waste is treated as a liquid and stored in lagoons-large, open, earth-walled containment structures situated on hog farms. The waste is slowly broken down by anaerobic bacteria and can then be sprayed back into the air to fertilize adjacent cropland.

Recently, the pork industry has faced scrutiny from environmental regulators for the continued use of these lagoon and spray-field systems due to a host of environmental concerns including groundwater contamination from lagoon system failures, and excessive rainfall causing overflow wherein manure pathogens mix with floodwaters and eventually end up in nearby rivers and tributaries. Additionally, concerns have been raised regarding the aerial emissions of pollutants from pork production facilities and their lagoons including ammonia, methane, hydrogen sulfide, and other volatile organic compounds. Researchers have begun studying potential harmful effects these compounds have on human health as well as dust, particulate matter, odor emissions, and other detrimental impacts from the open storage of hog waste generated at animal production facilities, often known as CAFOs—“confined animal feeding operations”.

As pork production and consumption continues to grow annually, state and federal legislators have put in place some environmental regulations for hog farms as well as incentives to develop and implement innovative technologies to mitigate current and future environmental issues and human health concerns.

As such, there remains a need for a swine lagoon cleaning process that efficiently and affordably manages animal waste stored in lagoons, and in particular a cleaning process that converts animal waste into value added materials such as marketable soil amendments, compost, fertilizer, asphalt, roof shingles, and/or the like. There is also a need for improved sewer systems in animal production facilities and/or farms for effective management and utilization of animal waste thereby converting and/or eliminating the need of swine lagoons and spray-field systems for waste capture and retainment.

### SUMMARY

The present teachings meet one or more of the present needs by providing: a method for cleaning animal waste lagoons comprising the steps of (a) deploying equipment to a livestock lagoon site including an agitation boat, a liquid-solid separator, a sludge pump, and a roll-off trailer; (b) agitating and loosening sludge that has formed within a lagoon; (c) positioning a pipeline from a sludge pump to a liquid-solid separator; (d) allowing sludge from the lagoon to flow through said pipeline to the liquid-solid separator via the use of the sludge pump; (e) separating the effluent (liquid) waste portion from the solid waste portion via the liquid-solid separator; (f) returning the separated effluent (liquid) waste portion to the lagoon or to a holding tank; (g) capturing, dewatering, and depositing the solid waste into a roll-off trailer; and (h) converting the solid waste into a useable form at an off-site recycling facility.

The present teachings meet one or more of the present needs by providing: a method for the installation and use of a swine sewer system, the system including (a) the laying of one or more underground pipelines to connect a hog house to one or more permanent liquid-solid separators and at least one water treatment system; and (b) allowing waste from the hog house to flow through said one or more pipelines to at least one permanent liquid-solid separator, wherein an effluent (liquid) waste portion is separated from a solid waste portion, the separated effluent portion is returned to one or more lagoons and/or one or more holding tanks, and the solid waste portion is captured, dewatered, and deposited into one or more roll-off trailers.

The one or more pipelines may comprise a material selected from polymers, metals, clays, concrete, or any combination thereof.

The one or more food grade polymers are selected from high-density polyethylene (HDPE), low-density polyethylene (LDPE), polyethylene terephthalate (PET/PETE), polypropylene (PP), polycarbonate (PC), acrylic, Nylon, or any combination thereof.

The present teachings overcome the above concerns by providing a unique method and system for the effective cleaning, management, and utilization of animal waste. Among the benefits of the teachings is that the waste generated from the animal production facilities can be converted into useful forms; for example, the animal waste may be mixed with feedstock and composted into marketable soil amendments, compost, fertilizer, mulch, and the like. Additionally, it is contemplated that the solid waste material may be converted for use in making roof shingles, carpet glue, asphalt, railroad ties and the like. Another benefit from the teachings is that the swine sewer system of the present invention can help alleviate the production and release of volatile organic substances into the atmosphere as well as help to dampen and/or eliminate the aerial spread of particulate matter, dust, and odors from the animal production facilities and hog lagoons to nearby neighborhoods. Furthermore, the swine sewer system of the present teachings is safer for the environment and for human health as animal waste is better contained in enclosed pipelines. As such, the swine sewer system of the present teachings may help to eliminate the dependence on lagoon and spray-field systems predominantly utilized in the industry today.

### BRIEF DESCRIPTION OF THE DRAWINGS

FIG. 1 illustrates a flow diagram of the steps comprising the mobile lagoon cleaning process.

FIG. 2 illustrates a flow diagram of the steps comprising the installation and use of the livestock sewer system.

### DETAILED DESCRIPTION

The explanations and illustrations presented herein are intended to acquaint others skilled in the art with the invention, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

As will be seen in further detail in the following discussion, in one aspect of the teachings, there is envisioned a method for cleaning livestock waste treatment lagoons (e.g., hog lagoons). The method may include providing a mobile crew on-site to a hog lagoon with an agitation boat, piping, a liquid-solid separator, a sludge-pump, and a roll-off trailer. The method may include the step of agitating and loosening sludge that has formed and settled on or near the bottom of the lagoon to be cleaned; laying pipes from the sludge pump to the liquid-solid separator; allowing sludge from the lagoon to flow through the laid pipeline (via the use of the sludge pump) to the liquid-solid separator; and wherein the method includes separating the effluent (liquid) waste portion from the solid waste portion; returning the separated effluent (liquid) portion to the lagoon and/or holding tank; and capturing, dewatering, and depositing the solid waste portion into a roll-off trailer. The method may further include converting the solid waste product into value added materials at an off-site recycling facility.

The method may include the step of agitating and loosening sludge that has formed and settled on or near the bottom of the hog lagoon to be cleaned. Agitating and/or loosening sludge may employ an agitation boat. The agitation boat may be a remote-controlled amphibious boat. However, it is contemplated that any suitable agitation device or dredging machinery known in the art and literature may be utilized to agitate the hog lagoon.

The method may include laying pipes from the sludge pump to the liquid-solid separator. It is contemplated that any suitable pipe material, length, and diameter known in the art and literature may be utilized to facilitate the procedure. Furthermore, the necessary location of the pipeline, sludge pump, and liquid-solid separator would be apparent to those skilled in the art to achieve the intended results.

The method may include allowing sludge from the hog lagoon to flow through the laid pipeline to the liquid-solid separator. Flow of the sludge from the hog lagoon through the pipeline to the liquid-solid separator may be aided by the use of a sludge pump. As mentioned herein, the necessary location of the pipeline, sludge pump, and liquid-solid separator would be apparent to those skilled in the art to achieve the intended purpose.

t\The one or more underground pipes comprise a material selected from polymers, metals, clays, concrete, or any combination thereof.

The method may include separating the effluent (liquid portion) from the solid waste portion of the sludge. Separating the effluent (liquid portion) from the solid waste portion of the sludge may employ a liquid-solid separator. It is contemplated that any known or suitable liquid-solid separator known in the art and literature may be utilized to separate the liquid portion from the solid waste portion of the hog lagoon sludge.

The liquid-solid separator may utilize one or more polymeric materials to assist in the separation process. The polymers selected may include food-grade polymers which may be selected from high-density polyethylene (HDPE), low-density polyethylene (LDPE), polyethylene terephthalate (PET/PETE), polypropylene (PP), polycarbonate (PC), acrylic, Nylon, or any combination thereof.

The method may include returning the separated effluent (liquid) portion to the hog lagoon and/or holding tank. The separated effluent (liquid) portion may be treated prior to returning to the hog lagoon. The separated effluent (liquid) portion may be untreated prior to returning to the hog lagoon. The separated effluent (liquid) portion may be routed to a holding tank. The separated effluent (liquid) portion may be treated prior to storage in the holding tank. The separated effluent (liquid) portion may be reused to clean hog houses, utilized in hog house pits, recycled for irrigation or the like. Furthermore, it is contemplated that the separated effluent (liquid) portion may be treated in such a manner as would convert it into potable water, extending its range of use thereof.

The method may include capturing, dewatering, and depositing the solid waste portion into a roll-off trailer. The captured solid waste may be hauled to an off-site facility for disposal or recycling.

The method may further include converting the solid waste product into value added materials. For example, it is contemplated that the solid waste material may be mixed with feedstock and composted into marketable soil amendments, compost, fertilizer, mulch, and the like. By way of another non-limiting example, the solid waste material may be converted for use in making roof shingles, carpet glue, asphalt, railroad ties and the like.

The teachings herein also contemplate a method for installing and using a sewer system for affordable and efficient management and utilization of animal waste in animal production facilities and/or farms. The method may include first employing a mobile lagoon cleaning process in full or in part, as described herein above, to a waste lagoon. The method may further include laying one or more underground pipes to connect the hog house to the liquid-solid separator and water treatment system. The method may include allowing waste from a livestock housing to flow through the one or more underground pipes to one or more permanent liquid-solid separators.

The method may include separating the effluent (liquid) waste portion from the solid waste portion. The separated effluent portion may be returned to the lagoon. The separated effluent portion may be returned to a holding tank. The solid waste portion may be captured, and/or dewatered. The solid waste portion may then be and deposited into a roll-off trailer. The method may further include converting the solid waste product into value added materials at an off-site recycling facility.

The method may include the first employing the mobile lagoon cleaning method as described herein in full or in part, to a lagoon. It is also contemplated that the lagoon is cleaned by other sufficient means prior to laying of the underground pipes.

The method may include laying underground pipes to connect the livestock housing to the liquid-solid separator and water treatment system. It is contemplated that any suitable pipe material, length, and diameter known in the art and literature may be utilized to facilitate the procedure. Furthermore, the necessary location and depth of the underground pipeline, as well as the location of the liquid-solid separator and water treatment system would be apparent to those skilled in the art to achieve the intended results.

The liquid-solid separators may utilize one or more polymeric materials to assist in the separation process. The polymers selected may include food-grade polymers which may be selected from high-density polyethylene (HDPE), low-density polyethylene (LDPE), polyethylene terephthalate (PET/PETE), polypropylene (PP), polycarbonate (PC), acrylic, Nylon, or any combination thereof.

The method may include allowing waste from the hog house to flow through the pipeline to the permanent liquid-solid separator. Flow of the waste from the hog house through the pipeline to the permanent liquid-solid separator may be aided by the use of a sludge pump.

The method may include separating the effluent (liquid portion) from the solid waste portion of the sludge. Separating the effluent (liquid portion) from the solid waste portion of the sludge may employ the permanent liquid-solid separator. It is contemplated that any known or suitable liquid-solid separator known in the art and literature may be utilized to separate the liquid portion from the solid waste portion of the hog lagoon sludge.

The method may include returning the separated effluent (liquid) portion to the hog lagoon and/or holding tank. The separated effluent (liquid) portion may be treated prior to returning to the hog lagoon. The separated effluent (liquid) portion may be untreated prior to returning to the hog lagoon. The separated effluent (liquid) portion may be routed to a holding tank. The separated effluent (liquid) portion may be treated prior to storage in the holding tank. The separated effluent (liquid) portion may be reused to clean hog houses, utilized in hog house pits, recycled for irrigation or the like. Furthermore, it is contemplated that the separated effluent (liquid) portion may be treated in such a manner as would convert it into potable water, extending its range of use thereof.

The method may include capturing, dewatering, and depositing the solid waste portion into a roll-off trailer. The captured solid waste may be hauled to an off-site facility for disposal or recycling.

The method may further include converting the solid waste product into value added materials. For example, it is contemplated that the solid waste material may be mixed with feedstock and composted into marketable soil amendments, compost, fertilizer, mulch, and the like. By way of another non-limiting example, the solid waste material may be converted for use in making roof shingles, carpet glue, asphalt, railroad ties and the like.

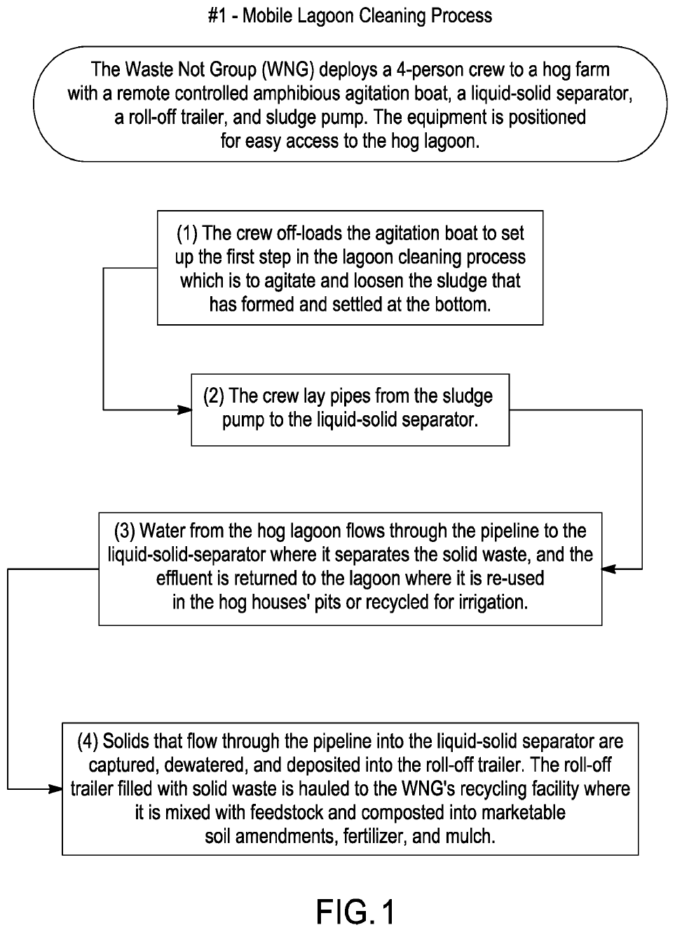

Turning now to the figures, as shown for example in FIG. 1, is a flow diagram of the steps comprising the mobile lagoon cleaning process from sludge to value added materials such as marketable soil amendments.

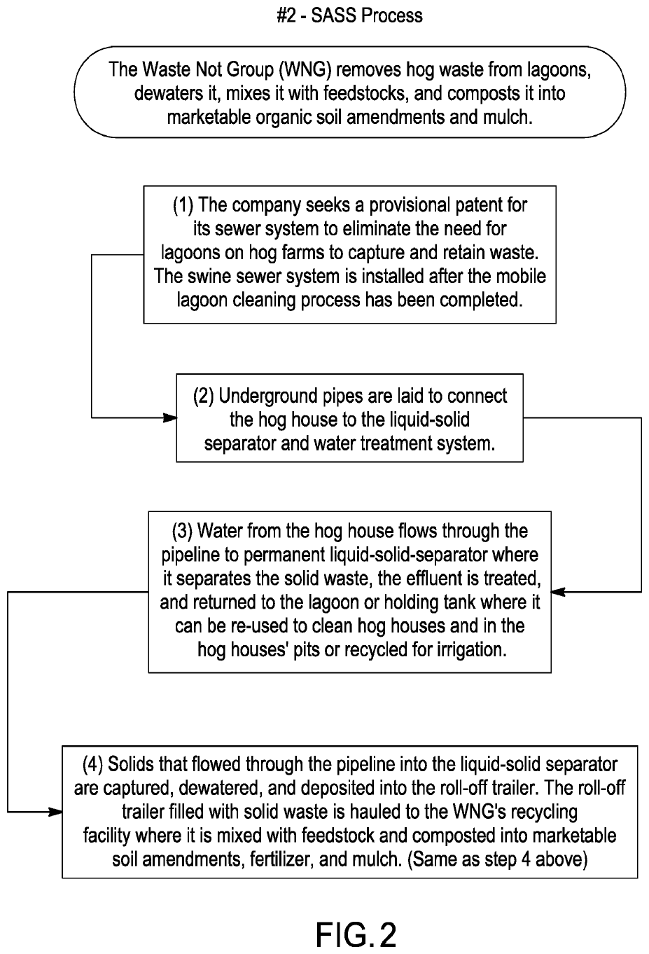

As shown for example in FIG. 2, is a flow diagram of the steps comprising the installation and use of the swine sewer system, which may be installed after the mobile lagoon cleaning process is completed.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps. By use of the term “may” herein, it is intended that any described attributes that “may” be included are optional.

Unless otherwise stated, a teaching with the term “about” or “approximately” in combination with a numerical amount encompasses a teaching of the recited amount, as well as approximations of that recited amount. By way of example, a teaching of “about 100” encompasses a teaching of 100+/−15.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

1. A method for cleaning animal waste lagoons, the method comprising the steps of:
a) deploying equipment to a lagoon site including at least one agitation boat, one or more liquid-solid separators, at least one sludge pump, and at least one roll-off trailer;
b) agitating and loosening a sludge that has formed within a lagoon via the at least one agitation boat;
c) positioning one or more pipelines from the at least one sludge pump to the one or more liquid-solid separators;
d) allowing the sludge from the lagoon to flow through said one or more pipelines to the one or more liquid-solid separators via the use of the at least one sludge pump;
e) separating an effluent (liquid) waste portion from a solid waste portion via the one or more liquid-solid separators;
f) optionally contacting the effluent (liquid) waste portion and/or solid waste portion with one or more food-grade polymers;
g) returning the separated effluent (liquid) waste portion to the lagoon or to one or more holding tanks; and
h) capturing, dewatering, and depositing the solid waste into the at least one roll-off trailer.

2. The method of claim 1, wherein the agitating step (b) is performed by a remote-controlled amphibious agitation boat.

3. The method of claim 1, wherein the method includes step (i) that comprises converting the solid waste into a useable form at an off-site recycling facility.

4. The method of claim 1, wherein the solid waste is mixed with feedstock and composted into one or more of marketable soil amendments, compost, fertilizer, mulch, or any combination thereof.

5. The method of claim 3, wherein the solid waste is converted for use in roof shingles, carpet glue, asphalt, and/or railroad ties

6. The method of claim 1, wherein the separated eluent (liquid) waste portion is treated for potable water reuse.

7. The method of claim 1, wherein the one or more food grade polymers are selected from high-density polyethylene (HDPE), low-density polyethylene (LDPE), polyethylene terephthalate (PET/PETE), polypropylene (PP), polycarbonate (PC), acrylic, Nylon, or any combination thereof.

8. The method of claim 1, wherein a sewer system is installed after the mobile lagoon cleaning process has been completed, the sewer system comprising:
a) the laying of one or more underground pipes to connect a housing for livestock to one or more permanent liquid-solid separators and a water treatment system; and
b) allowing waste from the housing for livestock to flow through said one or more underground pipes to the permanent liquid-solid separator.

9. The method of claim 8, comprising converting the solid waste into a usable form at an off-site recycling facility.

10. The method of claim 8, wherein the solid waste is mixed with feedstock and composted into marketable soil amendments, compost, fertilizer, mulch, and combinations thereof.

11. The method of claim 8, wherein the solid waste is converted for use in making roof shingles, carpet glue, asphalt, and/or railroad ties.

12. A method comprising:
c) agitating and loosening a sludge that has formed within a lagoon via at least one agitation boat;
d) positioning one or more pipelines from at least one sludge pump to one or more liquid-solid separators;
e) allowing the sludge to flow through the one or more pipelines to the one or more liquid-solid separators via the at least one sludge pump.

13. The method of claim 12, including separating an effluent (liquid) waste portion from a solid waste portion via the one or more liquid-solid separators.

14. The method of claim 12, including contacting the effluent (liquid) waste portion and/or solid waste portion with one or more food-grade polymers.

15. The method of claim 12, including returning the separated effluent (liquid) waste portion to the lagoon or to one or more holding tanks.

16. The method of claim 12, including capturing the solid waste and depositing the solid waste into at least one roll-off trailer.

17. The method of claim 15, including dewatering the solid waste and depositing the solid waste into at least one roll-off trailer.

18. The method of claim 15, wherein the one or more pipelines comprise a material selected from polymers, metals, clays, concrete, or any combination thereof.

19. The method of claim 12, wherein the one or more food grade polymers are selected from high-density polyethylene (HDPE), low-density polyethylene (LDPE), polyethylene terephthalate (PET/PETE), polypropylene (PP), polycarbonate (PC), acrylic, Nylon, or any combination thereof.

20. A method of instating a permanent sewer system for lagoon cleaning has comprising:
a) laying of one or more underground pipes to connect a housing for livestock to one or more permanent liquid-solid separators and a water treatment system; and
b) allowing waste from the housing for livestock to flow through said one or more underground pipes to the permanent liquid-solid separator.

21. (canceled)
